(19) United States
(12) Patent Application Publication
(10) Pub. No.: US 2007/0014965 A1
(43) Pub. Date: Jan. 18, 2007

(54) Gasket material for use in high pressure, high temperature apparatus

(76) Inventors: Robert Chodelka, Sarasota, FL (US); Hexiang Zhu, Sarasota, FL (US); Alexander Novikov, Sarasota, FL (US); John Clement, Sarasota, FL (US)

Correspondence Address: NATH & ASSOCIATES, 112 South West Street, Alexandria, VA, 22314, US

(21) Appl. No.: 11/165,543

(22) Filed: Jun. 24, 2005

(51) Int. Cl. B32B 3/02; F16J 15/00; B32B 15/04

(52) U.S. Cl. 428/66.4; 428/457; 277/300

(57) ABSTRACT

A gasket comprises a material having a creep relaxation of about 5-40%, a sealability of about 0.10-0.50 ml/hr, compressibility of about 5-40% and a tensile strength of about 1000-5000 psi. The gasket is used in a high pressure, high temperature apparatus.

### BACKGROUND OF THE INVENTION

1. Field of the Invention

The present inventive subject matter relates to materials suitable for use in a high pressure, high temperature apparatus. In particular, the materials are suitable for use as gaskets for sealing a reaction core in the high pressure, high temperature apparatus.

2. Description of the Prior Art

Synthetic diamonds are manufactured by a process of applying extreme pressure (e.g., 65 kilobars) to a quantity of a carbon source disposed within a container, and heating the container under pressure to a sufficient temperature wherein the diamond is thermodynamically stable. A high pressure, high temperature apparatus is often used to apply the necessary pressure and heat to the carbon source to achieve conversion of the graphite to the more thermodynamically stable diamond. In one process the pressure is applied to the container by a number of dies in a growth chamber. The high pressure, high temperature apparatus may have six dies that are each positioned at 90 degree angles with respect to the sides of the generally rectangular container and converge when the press is operated to surround the container, i.e., position the dies on each of the six sides of the container. A sealing gasket is often interposed between each of the dies. The gasket acts to perfect a pressure seal between adjacent die edge portions, forming a sealed pressure chamber therebetween, and transmits the pressure force exerted by each die to the container.

In many prior art methods and apparatuses for forming synthetic diamonds, the sealing gasket is machined from a block of pyrophyllite, a natural form of hydrous aluminum silicate found in metamorphic rocks. Pyrophyllite has been used as the preferred gasket material because of its physical properties of being able to deform or flow under pressure, to a limited extent to perfect a pressure seal and to transmit the pressure force from the dies to the container. Pyrophyllite also displays good thermal insulating characteristics that help to reduce the amount of heat that is used in the process to make synthetic diamonds.

However, the use of a gasket formed from pyrophyllite introduces variation and inconsistency into the high-pressure process. Because pyrophyllite is a natural material and, therefore, has inconsistencies in its composition, the physical properties of a sealing gasket formed from pyrophyllite also display such inconsistencies. For example, variations in pyrophyllite composition and moisture content are well known. Such variations have an impact on the operation of the high pressure, high temperature apparatus and the quality of the synthetic diamond being produced, as these variations affect the flow, pressure transmitting, and thermal insulating characteristics of the resulting gasket material formed from the pyrophyllite. Variations in composition and moisture content of gasket materials formed from pyrophyllite reduce product consistency, reduce product yield, and increase damage to the high pressure, high temperature apparatus.

Attempts have been made to overcome the variations in composition and moisture of natural pyrophyllite and the problems brought about because of the variations. The attempts to overcome the variations often focus on the production and use of other materials as gasket materials in high pressure, high temperature settings. For example, Yui et al., in U.S. Pat. No. 4,124,562, disclose a filled polyolefin composition based upon a polyolefin resin filled with a mechanico-chemically modified filler. The filler, which may be the usual filler material, is modified by mechanically exposing fresh surfaces of the original filler particles in the presence of a polymer of a vinyl monomer. The vinyl monomer should have at least one polar group capable of bonding with the freshly exposed surfaces of filler material as they are formed and exposed during the mechanical operation. The process for the production of the modified filler is also disclosed.

Tracy et al., in U.S. Pat. No. 4,786,670, disclose a non-asbestos compressible sheet material usable for high-temperature gaskets preferably containing 10-50% by weight of an inorganic fibrous material, 10-90% by weight of an inorganic filler material, 4-30% by weight of an organic elastomeric binder, 2-10% by weight of an inorganic silicate binder and 1.0-10% of an organic fibrous material. The sheet material may be manufactured on standard paper-making machinery.

Newman et al., in U.S. Pat. No. 4,861,076, disclose a sanitary pipe fitting and improved gasket for use in such fitting wherein the pipe fitting comprises first and second pipes, a gasket, and a nut for securing the ends of the pipes in an assembled relation with the gasket sandwiched therebetween. The pipes each terminate in an end face which has a conical surface and a radial shoulder, the shoulder of one pipe being located on the inside of the pipe and the shoulder of the other pipe being on the outside of the pipe. The gasket is annular and has end faces complementary in shape to the end faces of the pipes. The gasket is molded from a fiber-reinforced elastomeric material.

Lindeman et al., in U.S. Pat. Nos. 4,946,737 and 5,132,061, disclose a gasket which contains microspheres which expand inside the gasket sheet material after the gasket sheet is formed. Such gaskets are especially useful to provide a seal against fluid leaks at significantly lower pressures due to the presence of the microspheres. Some microspheres can expand during use.

Amano et al., in U.S. Pat. No. 5,416,149, disclose a pulp-like composite material free from the problems possessed by wood pulp and useful as a possible substitute for asbestos, and a process for production thereof. The pulp-like composite material comprises (a) an inorganic material other than asbestos and (b) a polycarbodiimide, wherein the inorganic material (a) is substantially covered by the polycarbodiimide (b), or, the inorganic material (a) is substantially covered by the polycarbodiimide (b) and the coated inorganic material is connected to each other. The process for producing the pulp-like composite material comprises dispersing an inorganic material other than asbestos in at least either of a polycarbodiimide solution and a precipitant and then mixing the resulting polycarbodiimide solution with the resulting precipitant while applying, as necessary, a shear force or a beating force.

Akita, in U.S. Pat. No. 5,709,956, discloses a gasket material including a sheet metal having a coating of adhesive applied thereon, and a coating layer of a compound or composition formed on the surface of the sheet metal, the compound or composition containing a fibrous material, fine cork particles and a rubber material. The gasket material provides improved material properties, including increased tensile strength, reduced stress relaxation, increased wear resistance and the like, while maintaining the capability of restoring itself from an applied compression.

Yamabe et al., in U.S. Pat. No. 5,709,956, discloses an extruded product comprising a rigid portion (1) and a flexible portion (2) which are co-extruded, wherein the rigid portion (1) is made of a resin or resin composition having a deflection temperature under load of from 80° to 120° C. as measured by JIS K 7207 A-method, and the flexible portion (2) is made of a resin composition comprising from 5 to 75 wt % of a vinyl chloride resin, from 5 to 70 wt % of a partially crosslinked acrylonitrile-butadiene copolymer and from 10 to 65 wt % of a plasticizer.

Akita, in U.S. Pat. No. 5,731,040, discloses a method for manufacturing gasket material where a metal plate is coated with a compound that includes a compressible inorganic fiber, other than asbestos, a compressible organic fiber, and rubber and an inorganic filler. In forming the gasket material, the metal plate is coated with a heat resistant adhesive. The metal plate is then inserted between first and second metal rollers that are arranged adjacent and parallel to each other, rotate at different circumferential speeds to one another and in opposite directions, and heat resistant adhesive layer applied over the metal plate is opposed by the first roller. While rolling, the compound with a solvent mixed therein is supplied to between the metal plate and the first roller that is turned at a circumferential speed that is slower than that of the second roller. The difference in the circumferential speeds of the first and second rollers provide for rubbing the compound over the entire metal plate surface, so as to uniformly coat the metal plate with the compound.

Carter et al., in U.S. Pat. No. 5,858,525, disclose a synthetic gasket material for use in a high-pressure press. The gasket material includes a major proportion of clay mineral powder having sufficient lubricity to flow in a high-pressure press, a minor proportion of at least one hard material powder having a sufficiently greater hardness than the clay mineral to retard flow of the clay mineral and form a seal during pressing in a high-pressure press, and a sufficient amount of binder to form an integral body. The synthetic gasket material is formed by thoroughly mixing together in desired proportions the clay mineral, hard material, and binder. The mixture is compacted into a body near net geometry and having a desired configuration to facilitate use in the high-pressure press. The compacted body is heated for a sufficient time and at a sufficient temperature to remove non-crystallographic water. The synthetic gasket material displays improved flow, pressure transmitting, and thermal insulating properties when compared with gasket material made from natural pyrophyllite, due to the improved compositional consistency, i.e., lack of impurities and consistently low moisture content, of the synthetic gasket material.

Cannon et al., in U.S. Pat. No. 6,338,754, disclose a synthetic gasket material and the method for make the same. The gasket material is specially adapted for use in high-pressure, high-temperature presses. This material is made from a compacted, granulated and dried mixture of talc, garnet, and sodium silicate. This composition provides an alternative to the use of natural pyrophyllite as the material for gasket components, thereby reducing the cost of the materials. This composition can be pressed to net or near net geometry, thereby generating less waste. Moreover, this composition provides more consistency for the gasket components. Furthermore, this material has improved thermal insulator properties, thereby leading to lower power consumption used in the high-pressure, high-temperature presses.

### BRIEF SUMMARY OF THE INVENTION

Applicants have developed a gasket comprising a material having a creep relaxation of about 5-40%, a sealability of about 0.10-0.50 ml/hr, compressibility of about 5-40% and a tensile strength of about 1000-5000 psi, wherein said gasket is used in a high pressure, high temperature apparatus.

Applicants have further developed a method of providing a seal in a growth chamber of a high pressure, high temperature apparatus comprising:
a) placing a reaction core in said growth chamber;
b) providing a plurality of anvils or dies to apply pressure to said reaction core;
c) positioning at least one gasket between each of said plurality of anvils or dies;
d) applying pressure to said reaction core by way of said plurality of anvils or dies, thereby causing said at least one gasket to deform and form a seal around said reaction core;

wherein said gasket comprises a material having a creep relaxation of about 5-40%, a sealability of about 0.10-0.50 ml/hr, compressibility of about 5-40% and a tensile strength of about 1000-5000 psi.

Furthermore, Applicants have developed a gasket comprising a material having a creep relaxation of about 5-40%, a sealability of about 0.10-0.50 ml/hr, compressibility of about 5-40% and a tensile strength of about 1000-5000 psi;

wherein said gasket is positioned between a plurality of anvils or dies in a growth chamber of a high pressure, high temperature apparatus and has at least one metal strip of relatively hard material attached to the top thereof.

### BRIEF DESCRIPTION OF THE DRAWINGS

Embodiments of the present inventive subject matter are described by way of example and with reference to the accompanying drawings wherein:

FIG. 1 is an enlarged perspective view of an embodiment of the present inventive subject matter;

FIG. 2 is a cross-sectional view of a portion of a growth chamber in which the present inventive gasket may be used; and

FIG. 3 is a perspective view of a die with a plurality of gaskets affixed thereto.

### DETAILED DESCRIPTION OF THE EMBODIMENTS

The present inventive subject matter is drawn to a gasket for use in a high pressure, high temperature apparatus comprising a material having a creep relaxation of about 5-40%, a sealability of about 0.10-0.50 ml/hr, compressibility of about 5-40% and a tensile strength of about 1000-5000 psi.

The present inventive material to be used in a high pressure, high temperature apparatus generally has a creep relaxation of about 5-40%. As used herein, the term “creep relaxation” refers to a transient stress-strain condition in which the strain increases concurrently with a decay in stress. Creep relaxation indicates the gasket material's ability to maintain initial performance after exposure to stress, temperature and time. Lower creep values indicate materials that are better at sustaining pressure. A method of testing the creep relaxation is provided by the ASTM F38 in which the creep relaxation of a material is measured at a stated time after a compressive stress has been applied. ASTM International is a recognized developer of standards relating to materials, products, systems and services. The various standards recognized in this application refer to standards developed by ASTM International.

In another aspect of the present inventive subject matter, the inventive material has a creep relaxation of about 5-40%, preferably about 15-25%, as measured by ASTM F38. In a further aspect, the present inventive material has a creep relaxation of about 20% as measured by ASTM F38.

The present inventive gasket material also has a particular sealability that is important for performance in a high pressure, high temperature apparatus. As used herein, the term “sealability” refers to the sealing properties of the gasket materials at room temperature. Many test methods used to determine the sealability of a material evaluate the sealing characteristics under different loads. The tests for sealability are designed to compare gasket materials under controlled conditions and to provide a precise measure of leakage rate. A particular method to determine the sealability of a material is provided by ASTM F37A, which measures the liquid leak properties of a material.

The material of the present inventive subject matter has a sealability of about 0.10-0.50 ml/hr as measured by ASTM F37A. In another aspect of the present inventive subject matter, the inventive material has a sealability of about 0.20-0.30 ml/hr, preferably about 0.24-0.26 ml/hr. In a further aspect, the present inventive subject matter comprises a material having a sealability of about 0.25 ml/hr.

The material of the present inventive subject matter further has a particular compressibility in order for the material to function properly in a high pressure, high temperature apparatus. The expression “compressibility” as used herein refers to the ability of molecules in a material to be compacted or compressed (made more dense) and their ability to bounce back to their original density; in other words, the “springiness” of the molecules in the material is measured. An incompressible material cannot be compressed and has relatively constant density throughout. Compressibility is contrasted with creep as defined above in that compressibility refers to short duration stress being applied to the material, whereas creep refers to a prolonged exposure of the material to the stress. A method to evaluate the compressibility of a material is provided in ASTM F36, which provides for tests regarding the compressibility and recovery of various materials.

In an aspect of the present inventive subject matter, the material to be used in a high pressure, high temperature apparatus has a compressibility of about 5-40%. In a further aspect, the present inventive material has a compressibility of about 7-17%, preferably about 10-15%. In addition, the recovery of the present inventive material is 50% at a minimum. The recovery of the material is defined as the ability of the material to return to its pre-compressed state.

The material of the present inventive subject matter also has a definite tensile strength. “Tensile strength,” as used herein, refers to the resistance of a material to a force tending to tear it apart, measured as the maximum tension the material can withstand without tearing. In other words, the tensile strength is a measurement of the force per unit area required to pull a material apart longitudinally. A method to evaluate the tensile strength, or tension testing, of a material is provided in ASTM F152, which is used for testing non-metallic gasket materials.

In an aspect of the present inventive subject matter, the inventive material has a tensile strength of about 1000-5000 pounds per square inch (psi). In a further aspect, the inventive material has a tensile strength of about 1500-3500 psi, preferably about 1900-2100 psi. In a still further aspect, the inventive material has a tensile strength of about 2000 psi.

The material of the present inventive subject matter has further properties that are important in the performance as a gasket in a high pressure, high temperature apparatus. In particular, the material has an electrical resistivity of about 10³-10⁷ ohm·cm, thermal stability above about 300° C. to about 1500° C. and a maximum weight increase of about 5-15% after submersion in Fuel B for 5 hours at 23° C.

The material of the present inventive subject matter has a particular electrical resistivity in order to provide proper electrical insulation between dies or anvils employed in the high pressure, high temperature apparatus in which the gasket made from the material is used. As used herein, “electrical resistivity” or “electrical resistance” is defined as a measurement of how strongly a material opposes the flow of electric current. A low resistivity indicates that a material readily allows the movement of electrons. A high resistivity indicates that a material is a good insulator.

The resistivity of metals is generally low, indicating that metals are good conductors of electrons and are not good insulators. For example, the resistivity of aluminum is 2.83×10⁻⁶ ohm·cm at 20° C., which indicates that aluminum is a good conductor of electricity. The standard unit of measure of resistivity is the “ohm·cm”.

The material employed in the gaskets of the present inventive subject matter has an electrical resistivity of about 10³-10⁷ ohm·cm, which indicates that the material is a good insulator. The importance of the gasket material being a good insulator is that the gasket material keeps the dies or anvils in the high pressure, high temperature apparatus from coming into contact with each other. Since an electric current may be running through the dies or anvils, the system may be shorted out if the dies or anvils contact one another, thus it is important that the material has a high electrical resistivity and acts as a good insulator. In another aspect of the present inventive subject matter, the material has an electrical resistivity of about 10⁴-10⁶ ohm·cm, preferably about 10⁶ ohm·cm.

In another aspect of the material of the present inventive subject matter, the material has good thermal stability. In other words, the material is able to withstand high temperatures without chemically degrading. It is understood that some mechanical degradation will occur at higher temperatures, that is, the material will soften under the high temperatures employed in the high temperature, high pressure apparatuses in which the gasket material is used. However, the material has a good thermal stability and does not degrade chemically under the application of the high temperatures.

The material of the inventive subject matter has good thermal stability (does not degrade) above about 300° C. to about 1500° C. In particular, the material has good thermal stability above about 600° C. to about 1200° C. A further aspect of the inventive subject matter is directed to a material that has good thermal stability above about 600° C.

A further property of importance with respect to the material in the present inventive subject matter is stability in oil. When used in the high pressure, high temperature apparatuses, the present inventive gasket material may come into contact with circulating oil, thus it is important that the material not react adversely with the oil. Measurements of a material's “oil stability” include the amount of weight increase and the amount of thickness increase the material experiences when contacted with an oil over a period of time. A test such as ASTM F146 is often used to quantify the amount of weight and/or thickness increase a material experiences when exposed to an oil over a given period of time.

The material of the present inventive subject matter has good oil stability. In particular, the material of the present inventive subject matter has a maximum 15% weight increase as measured by ASTM F146 after immersion in Fuel B for 5 hours at 23° C. In another aspect of this embodiment, the material has a weight increase of about 5-15% after immersion in Fuel B for 5 hours at 23° C., and preferably from 7-10% weight increase.

Another measurement reflective of a material's stability in oil is the amount of increase in the material's thickness after exposure to oil. ASTM F146 also allows one to determine the increase in the thickness of a material after exposure to an oil. In an aspect of the present inventive subject matter, the material used as a gasket experiences an increase in thickness of about 0-7% as measure in accordance with ASTM F146 after exposure to Fuel B for 5 hours at 23° C. In a further aspect, the material of the present inventive subject matter experiences an increase in thickness of 3-5%. However, the material preferably experiences no increase in thickness when exposed to oil for a period of time.

A still further property that is of importance with respect to the material of the present inventive subject matter is the dielectric strength. “Dielectric strength,” as used herein, is defined as the maximum working voltage a material can withstand without breaking down or losing its insulating properties. The dielectric strength is normally expressed as the voltage at which the material breaks down divided by the thickness of the material in millimeters (Volts/mm). A method for testing the dielectric strength of a material is ASTM D149.

The material of the present inventive subject matter has a dielectric strength of about 100-20,000 V/mm. In a further embodiment, the material has a dielectric strength of about 5,000 V/mm. In a still further embodiment, the material has a dielectric strength of about 16,000 V/mm.

It is important that the material of the present inventive subject matter has the characteristics defined above in order for the gasket material to perform properly in a high pressure, high temperature apparatus. If one of the characteristics is outside a defined range, then the material will not perform properly, potentially rendering useless the high pressure, high temperature apparatus in which the material was being used. For example, if the material used in the apparatus has a sealability value above 0.50 ml/hr, the gasket material will not form a strong enough seal within the apparatus, resulting in unusable product being formed within the apparatus.

Suitable materials that possess the necessary properties as defined and claimed herein include, without limitation, nitrile-based polymeric materials. However, other natural and synthetic polymeric materials modified or strengthened with inorganic or organic salts such as glass or ceramic fiber may also be used as suitable materials herein. Other such polymeric materials include, without limitation, polyvinyl chlorides, polyacrylates, polymethacrylates, polymethylmethacrylates, polyesters, polypropylenes, polyethylenes, and polyurethanes. In particular, suitable materials include KLINGERSIL® (Thermoseal Inc., Sidney, Ohio) products, including KLINGERSIL® C-4401 and KLINGERSIL® C-4430.

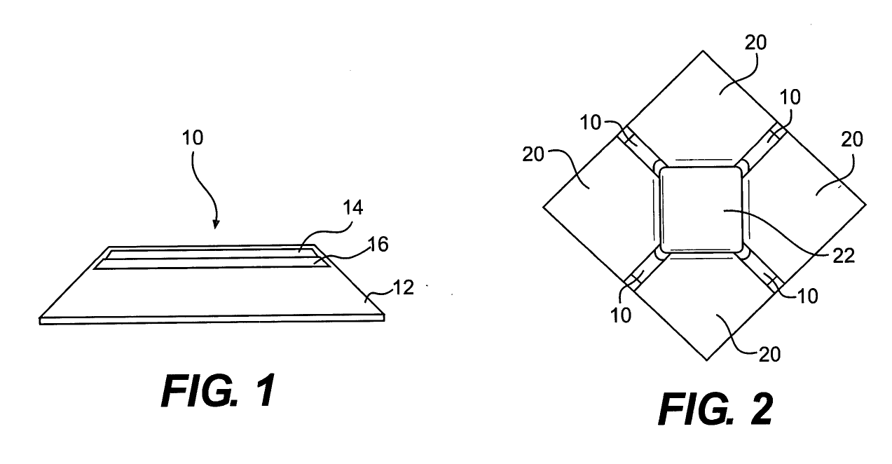

Turning now to the figures, FIG. 1 is a perspective view of an embodiment of a gasket 10 of the present inventive subject matter. Gasket 10 comprises a base 12 comprising the present inventive material. In the embodiment of FIG. 1, base 12 is in the shape of a trapezoid having two parallel sides of differing lengths. On top of base 12 are two strips of different material located proximate to the shorter side of trapezoidal base 12. A first strip 14, located closest to the shorter side, is comprised of a relatively hard material, while a second strip 16, located adjacent to first strip 14 and closer to the longer side of base 12, is comprised of a relatively soft material.

The relatively hard material of first strip 14 helps gasket 10 retain its general shape when high pressures and high temperatures are applied. The relatively hard material provides rigidity to the gasket as the base material is being deformed by the application of the high pressure and temperature. The relatively hard material may be a hard metal such as steel or titanium. In one aspect, the relatively hard material comprises a material selected from the group consisting of titanium, galvanized steel, tungsten carbide, and combinations thereof. In a further aspect, the relatively hard material of first strip 14 comprises titanium.

The relatively soft material of second strip 16 helps keep gasket 10 from slipping from between dies in a high pressure, high temperature apparatus. FIG. 2 shows a horizontal cross-section of a portion of a growth chamber in a high pressure, high temperature apparatus. FIG. 2 depicts the position of gaskets 10 between dies 20 in the growth chamber (the rest of the apparatus is not shown). As can be seen in FIG. 2, gaskets 10 are positioned between adjacent dies 20. Reaction core 22 is located in the center of the growth chamber. Dies 20 are located at each side of core 22, including the top and bottom (not shown), to apply pressure to core 22. Gaskets 10 are located between adjacent dies 20, and perform a multitude of functions in that position.

Gaskets 10 seal reaction core 22 from fluids flowing outside of dies 20, namely water that is used to cool the reaction core and oil that acts as a pressure medium within the growth chamber. The placement of gaskets 10 between dies 20 also allows the pressure being applied to reaction core 22 to reach equilibrium so that equal pressure is being applied to each side of reaction core 22. In addition, in the embodiment depicted in FIG. 2, reaction core 22 is heated by way of resistance heating as current is sent through dies 20 to heat reaction core 22. Gaskets 10 also act as an insulator, keeping dies 20 from touching each other which would result in shorting out the system.

As pressure is applied by dies 20 to reaction core 22, gasket 10 is compressed, but first strip 14 of relatively hard material helps gasket 10 retain its shape. In addition, second strip 16 of relatively soft material prevents gasket 10 from slipping from between dies 20. If a gasket 10 slides when pressure is being applied to reaction core 22 by dies 20, gasket 10 will not provide an adequate seal to the system and the pressure will not achieve equilibrium on reaction core 22. The relatively soft material of second strip 16 may be selected from the group consisting of aluminum, tin, copper, zinc, antimony, and combinations thereof. In an aspect of the present inventive subject matter, the relatively soft material comprises aluminum.

The embodiments of the present inventive subject matter shown in FIGS. 1 and 2 depict two strips of different material attached to the gasket. However, the present inventive subject matter also contemplates those embodiments in which only one of the strips is present on the gasket material. For example, the present inventive subject matter contemplates an embodiment in which only the strip of relatively hard material is attached to the base of the gasket; and the subject matter further includes an embodiment when only the strip of the relatively soft material is attached to the base of the gasket. One skilled in the art of high pressure, high temperature apparatuses will recognize that the performance characteristics of the gasket, and thus the performance of the high pressure, high temperature apparatus in which the gasket is used, will be altered based on the presence or absence of the particular strips on the base.

Furthermore, the present inventive subject matter also contemplates a gasket that does not contain either of the strips of material. In other words, the present inventive subject matter includes an embodiment in which only the base is present and acting as a gasket in a high pressure, high temperature apparatus. As with the presence or absence of one of the material strips, the performance characteristics of the material as a gasket may be changed when no strips of material are present on the gasket.

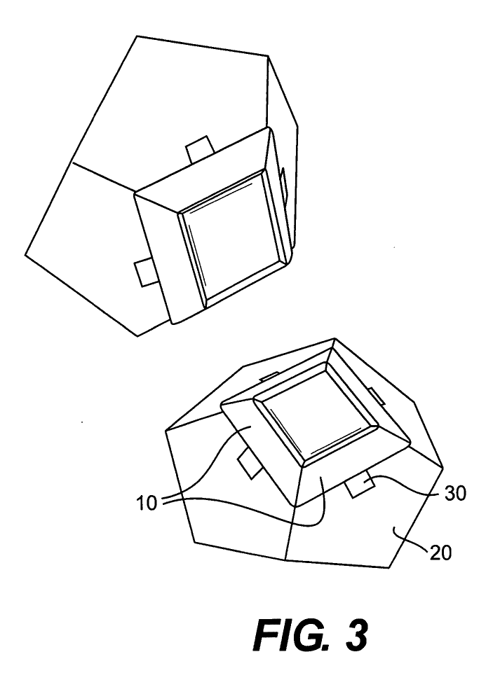

In one aspect of the present inventive subject matter, the gasket is assembled and affixed to the die prior to the die being positioned in the growth chamber of the high pressure, high temperature apparatus. FIG. 3 shows a plurality of gaskets 10 affixed to die 20. In the embodiment of FIG. 3, gaskets 10 are affixed to die 20 by way of tab 30, on which an adhesive is employed to keep gasket 20 in proper position as die 20 is being placed in the growth chamber. The adhesive may be any suitable adhesive for keeping gasket 10 in an initial position on die 20. In one aspect of the present embodiment, the adhesive is comprised of sodium silicate.

The present inventive subject matter is also drawn to a gasket comprising a material having a creep relaxation of about 5-40%, a sealability of about 0.10-0.50 ml/hr, compressibility of about 5-40% and a tensile strength of about 1000-5000 psi, wherein the gasket is positioned between a plurality of anvils or dies in a growth chamber of a high pressure, high temperature apparatus. FIG. 2 depicts a non-limiting example of the positioning of a suitable gasket in this embodiment of the present inventive subject matter.

The plurality of anvils or dies applies pressure to a reaction core located in the center thereof. The pressure applied to the reaction core can be up to about 850,000 pounds per square inch. The reaction core is charged with the necessary components for producing a desired product, such as a synthetic diamond, cubic boron nitride or a polycrystalline diamond. One of ordinary skill in the art will appreciate the necessary components for producing each of the above products and charge those components to the reaction core prior to positioning the core amongst the plurality of dies. For example, in the case of producing a synthetic diamond, a diamond seed, a graphite source, and a metal solvent/catalyst are charged into the reaction core. Diamond seed, graphite sources and metal solvent/catalysts are generally known in the art of making synthetic diamonds, and any such combination of components are suitable for use with the present inventive subject matter.

As the pressure is applied to the reaction core, the gaskets are deformed, thus forming a seal between the dies and around the reaction core. Heat is also added to the reaction core in the growth chamber in order to form the desired product within the reaction core.

In one aspect of this particular embodiment of the present inventive subject matter, the material from which the gasket is made has a creep relaxation of about 20%, a sealability of about 0.25 ml/hr, a compressibility of about 7-17%, and a tensile strength of about 2000 psi. Further, the gasket in this embodiment may have a first strip of a relatively hard material to help the gasket to retain its general shape when the high pressures and high temperatures are applied. The relatively hard material provides rigidity to the gasket as the base material is being deformed by the application of the high pressure and temperature. The relatively hard material may be a hard metal such as steel or titanium. In one aspect, the relatively hard material comprises a material selected from the group consisting of titanium, galvanized steel, tungsten carbide, and combinations thereof. In a further aspect, the relatively hard material of the first strip comprises titanium.

The gasket in this embodiment may also comprise a second strip of relatively soft material. The relatively soft material of the second strip may be selected from the group consisting of aluminum, tin, copper, zinc, antimony, and combinations thereof. In an aspect of this embodiment, the relatively soft material comprises aluminum.

An alternative aspect of this embodiment includes a gasket in which only one strip of material, either the relatively hard material or the relatively soft material, is positioned on top of the base.

The present inventive subject matter is further drawn to a method of providing a seal in a growth chamber of a high pressure, high temperature apparatus. The method comprises the steps of placing a reaction core in said growth chamber, providing a plurality of anvils or dies to apply pressure to the reaction core, positioning at least one gasket between each of the plurality of anvils or dies, and applying pressure to the reaction core by way of the plurality of anvils or dies, thereby causing the at least one gasket to deform and form a seal around the reaction core. In this embodiment, the gasket comprises a material having a creep relaxation of about 5-40%, a sealability of about 0.10-0.50 ml/hr, compressibility of about 5-40% and a tensile strength of about 1000-5000 psi.

The pressure applied to the reaction core is about 850,000 pounds per square inch. The reaction core is charged with the necessary components for producing a desired product, such as a synthetic diamond, cubic boron nitride or a polycrystalline diamond. One of ordinary skill in the art will appreciate the necessary components for producing each of the above products. As the pressure is applied to the reaction core, the gaskets are deformed, thus forming a seal between the dies and around the reaction core. Heat is also added to the reaction core in the growth chamber in order to form the desired product within the reaction core.

In one aspect of this embodiment of the present inventive subject matter, the material from which the gasket is made has a creep relaxation of about 20%, a sealability of about 0.25 ml/hr, a compressibility of about 7-17%, and a tensile strength of about 2000 psi. Further, the gasket in this embodiment may have a first strip of a relatively hard material to help the gasket to retain its general shape when the high pressures and high temperatures are applied. The relatively hard material provides rigidity to the gasket as the base material is being deformed by the application of the high pressure and temperature. The relatively hard material may be a hard metal such as steel or titanium. In one aspect, the relatively hard material comprises a material selected from the group consisting of titanium, galvanized steel, tungsten carbide, and combinations thereof. In a further aspect, the relatively hard material of the first strip comprises titanium.

The gasket in this embodiment may also comprise a second strip of relatively soft material. The relatively soft material of the second strip may be selected from the group consisting of aluminum, tin, copper, zinc, antimony, and combinations thereof. In an aspect of this embodiment, the relatively soft material comprises aluminum.

An alternative aspect of this embodiment includes a gasket in which only one strip of material, either the relatively hard material or the relatively soft material, is positioned on top of the base.

One of skill in the art of high pressure, high temperature apparatuses will appreciate that the embodiments described above are in relation to a split-sphere high pressure, high temperature apparatus. However, the embodiment described above is for illustrative purposes and should not be construed as limiting the inventive subject matter to use only in split-sphere high pressure, high temperature apparatuses.

Other high pressure, high temperature apparatuses are also usable in the present inventive subject matter. Examples of other high pressure, high temperature apparatuses include, without limitation, a belt-type apparatus, a piston-cylinder apparatus, an annular-die apparatus and a toroid apparatus. Each type of high pressure, high temperature apparatus is well-known in the art. For example, U.S. Pat. No. 4,301,134 to Strong describes a belt-type high pressure, high temperature apparatus usable in the present inventive subject matter, while U.S. Pat. No. 5,244,368 to Frushour describes a non-limiting example of a piston-cylinder high pressure, high temperature apparatus that is also usable in the present inventive subject matter. Likewise, U.S. Pat. No. 4,518,334 describes an annular-die high pressure, high temperature apparatus employable in the present inventive subject matter. Further, U.S. Pat. No. 4,290,741 to Kolchin et al. and U.S. Patent Application Publication No. 2004/0134415 to D'Evelyn et al. disclose toroid high pressure, high temperature apparatuses that are usable in the present inventive subject matter. The contents of each of the above-listed U.S. patents and published patent applications are hereby incorporated in their entirety.

In addition, the present inventive material and gaskets can be utilized in the various types of high pressure, high temperature apparatuses to produce a plurality of different products. In particular, the inventive gasket material is suitable for use in apparatuses for producing synthetic diamonds, polycrystalline diamond composites, cubic boron nitride, and the like.

The inventive subject matter being thus described, it will be obvious that the same may be varied in many ways. Such variations are not to be regarded as a departure from the spirit and scope of the inventive subject matter, and all such modifications are intended to be included within the scope of the following claims.

1. A gasket comprising a material having a creep relaxation of about 5-40%, a sealability of about 0.10-0.50 ml/hr, compressibility of about 5-40% and a tensile strength of about 1000-5000 psi, wherein said gasket is used in a high pressure, high temperature apparatus.

2. The gasket according to claim 1 wherein said material has a creep relaxation of about 20%.

3. The gasket according to claim 1 wherein said material has a sealability of about 0.25 ml/hr.

4. The gasket according to claim 1 wherein said material has a compressibility of about 7-17%.

5. The gasket according to claim 1 wherein said material has a tensile strength of about 2000 psi.

6. The gasket according to claim 1 further comprising a strip of a relatively hard material attached to said material.

7. The gasket according to claim 6 wherein said relatively hard material comprises a material selected from the group consisting of titanium, galvanized steel, tungsten carbide, and combinations thereof.

8. The gasket according to claim 7 wherein said relatively hard material comprises titanium.

9. The gasket according to claim 1 further comprising a strip of a relatively soft material attached to said material.

10. The gasket according to claim 9 wherein said relatively soft material comprises a material selected from the group consisting of aluminum, tin, copper, zinc, antimony, and combinations thereof.

11. The gasket according to claim 10 wherein said relatively soft material comprises aluminum.

12. The gasket according to claim 1 further comprising a strip of a relatively hard material and a strip of a relatively soft material attached to said material.

13. The gasket according to claim 12 wherein said relatively hard material comprises titanium and said relatively soft material comprises aluminum.

14. The gasket according to claim 1 wherein said material further has an electrical resistivity of about 10³-10⁷ ohm·cm, thermal stability above about 300° C. to about 1500° C., a dielectric strength of about 100-20,000 V/mm and a maximum weight increase of about 5-15% after submersion in Fuel B for 5 hours.

15. The gasket according to claim 1 wherein said high pressure, high temperature apparatus comprises an apparatus selected from the group consisting of a split-sphere apparatus, a belt-type apparatus, a piston-cylinder apparatus, an annular-die apparatus and a toroid apparatus.

16. A method of providing a seal in a growth chamber of a high pressure, high temperature apparatus comprising:
a) placing a reaction core in said growth chamber;
b) providing a plurality of anvils or dies to apply pressure to said reaction core;
c) positioning at least one gasket between each of said plurality of anvils or dies;
d) applying pressure to said reaction core by way of said plurality of dies, thereby causing said at least one gasket to deform and form a seal around said reaction core;
wherein said gasket comprises a material having a creep relaxation of about 5-40%, a sealability of about 0.10-0.50 ml/hr, compressibility of about 5-40% and a tensile strength of about 1000-5000 psi.

17. The method according to claim 16 wherein said material has a creep relaxation of about 20%.

18. The method according to claim 16 wherein said material has a sealability of about 0.25 ml/hr.

19. The method according to claim 16 wherein said material has a compressibility of about 7-17%.

20. The method according to claim 16 wherein said material has a tensile strength of about 2000 psi.

21. The method according to claim 16 wherein said gasket further comprises a strip of a relatively hard material attached to said material.

22. The method according to claim 21 wherein said relatively hard material comprises a material selected from the group consisting of titanium, galvanized steel, tungsten carbide, and combinations thereof.

23. The method according to claim 22 wherein said relatively hard material comprises titanium.

24. The method according to claim 16 wherein said gasket further comprises a strip of a relatively soft material attached to said material.

25. The gasket according to claim 24 wherein said relatively soft material comprises a material selected from the group consisting of aluminum, tin, copper, zinc, antimony, and combinations thereof.

26. The gasket according to claim 25 wherein said relatively soft material comprises aluminum.

27. The method according to claim 16 wherein said gasket further comprises a strip of a relatively hard material and a strip of a relatively soft material attached to said material.

28. The method according to claim 16 wherein said material further has an electrical resistivity of about 10³-10⁷ ohm·cm, thermal stability above about 300° C. to about 1500° C., a dielectric strength of about 100-20,000 V/mm and a maximum weight increase of about 5-15% after submersion in Fuel B for 5 hours.

29. The method according to claim 16 wherein said high pressure, high temperature apparatus comprises an apparatus selected from the group consisting of a split-sphere apparatus, a belt-type apparatus, a piston-cylinder apparatus, an annular-die apparatus and a toroid apparatus.

30. A gasket comprising a material having a creep relaxation of about 5-40%, a sealability of about 0.10-0.50 ml/hr, compressibility of about 5-40% and a tensile strength of about 1000-5000 psi;
wherein said gasket is positioned between a plurality of anvils or dies in a growth chamber of a high pressure, high temperature apparatus and has at least one metal strip of relatively hard material attached to the top thereof.

31. The gasket according to claim 30 wherein said material has a creep relaxation of about 20%.

32. The gasket according to claim 30 wherein said material has a sealability of about 0.25 ml/hr.

33. The gasket according to claim 30 wherein said material has a compressibility of about 7-17%.

34. The gasket according to claim 30 wherein said material has a tensile strength of about 2000 psi.

35. The gasket according to claim 30 further comprising a strip of a relatively hard material attached to said material.

36. The method according to claim 35 wherein said relatively hard material comprises a material selected from the group consisting of titanium, galvanized steel, tungsten carbide, and combinations thereof.

37. The method according to claim 36 wherein said relatively hard material comprises titanium.

38. The method according to claim 30 wherein said gasket further comprises a strip of a relatively soft material attached to said material.

39. The gasket according to claim 38 wherein said relatively soft material comprises a material selected from the group consisting of aluminum, tin, copper, zinc, antimony, and combinations thereof.

40. The gasket according to claim 39 wherein said relatively soft material comprises aluminum.

41. The gasket according to claim 30 further comprising a strip of a relatively hard material and a strip of a relatively soft material attached to said material.

42. The method according to claim 30 wherein said material further has an electrical resistivity of about 10³-10⁷ ohm·cm, thermal stability above about 300° C. to about 1500° C., a dielectric strength of about 100-20,000 V/mm and a maximum weight increase of about 5-15% after submersion in Fuel B for 5 hours.

43. The method according to claim 30 wherein said high pressure, high temperature apparatus comprises an apparatus selected from the group consisting of a split-sphere apparatus, a belt-type apparatus, a piston-cylinder apparatus, an annular-die apparatus and a toroid apparatus.
